(19) United States
(12) Patent Application Publication
(10) Pub. No.: US 2017/0316338 A1
(43) Pub. Date: Nov. 2, 2017

(54) FEATURE VECTOR GENERATION

(71) Applicant: Hewlett Packard Enterprise Development LP, Houston, TX (US)

(72) Inventors: Kave Eshghi, Los Altos, CA (US); Mehran Kafai, Redwood, CA (US); Omar Aguilar Macedo, Tlaquepaque Jalisco (MX)

(21) Appl. No.: 15/142,357

(22) Filed: Apr. 29, 2016

(51) Int. Cl. G06N 99/00; G06F 17/30

(52) U.S. Cl. CPC G06N 99/005; G06F 17/30598

(57) ABSTRACT

In some examples, a method includes accessing input vectors in an input space, wherein the input vectors characterize elements of a physical system. The method may also include generating feature vectors from the input vectors, and the feature vectors are generated without any vector product operations between performed between any of the input vectors. An inner product of a pair of the feature vectors may correlate to an implicit kernel for the pair of feature vectors, and the implicit kernel may approximate a Gaussian kernel within a difference threshold. The method may further include providing the feature vectors to an application engine for use in analyzing the elements of the physical system, other elements in the physical system, or a combination of both.

### BACKGROUND

With rapid advances in technology, computing systems are increasingly prevalent in society today. Vast computing systems execute and support applications that communicate and process immense amounts of data, many times with performance constraints to meet the increasing demands of users. Increasing the efficiency, speed, and effectiveness of computing systems will further improve user experience.

### BRIEF DESCRIPTION OF THE DRAWINGS

Certain examples are described in the following detailed description and in reference to the drawings.

FIG. 1 shows an example of a system that supports generation of feature vectors using concomitant rank order (CRO) hash sets.

FIG. 2 shows an example of an architecture that supports generation of feature vectors using CRO hash sets.

FIG. 3 shows an example graph to illustrate how an implicit kernel may differ from a Gaussian kernel by less than a difference threshold.

FIG. 4 shows a flow chart of an example method for feature vector generation.

FIG. 5 shows a flow chart of another example method for feature vector generation.

FIG. 6 shows an example of a system that supports generation of feature vectors using CRO hash sets.

### DETAILED DESCRIPTION

The discussion below refers to input vectors and feature vectors. An input vector may refer to any vector or set of values in an input space that represents an object and a feature vector may refer to a vector or set of values that represents the object in a feature space. Various transformational techniques may be used to map input vectors in the input space to feature vectors in the feature space. Kernel methods, for example, may rely on the mapping between the input space and the feature space such that the inner product of feature vectors in the feature space can be computed through a kernel function (which may also be denoted as the “kernel trick”). One such example is support vector machine (SVM) classification through the Gaussian kernel. Kernel methods, however, may be inefficient in that the direct mapping from the input space to the feature space is computationally expensive, or in some cases impossible (for example in the case of a Gaussian kernel where the feature space is infinite-dimensional).

Linear kernels are another form of machine learning that utilize input vectors, and may operate with increased effectiveness on specific types of input vectors (e.g., sparse, high-dimensional input vectors). However, when the input vectors are not of the specific types upon which such linear kernels can effectively operate, the accuracy of linear kernels may decrease. For linear kernels, no input-to-feature space mapping is performed (or the input-to-feature mapping is an identity mapping), and thus the effectiveness linear kernels is largely dependent on the input vectors being in a format that linear kernels effectively utilize. As such, real-time processing using such linear kernels may be less effective as such applications provide increased speed and efficiency, but the accuracy of the linear kernel may be insufficient for application or user-specified requirements.

Examples consistent with the present disclosure may support generation of feature vectors using concomitant rank order (CRO) hash sets. As described below, a CRO hash set for an input vector may be computed with high efficiency, and using the CRO hash set to map an input vector to a corresponding feature vector may also yield accuracy benefits that may be comparable to use of non-linear kernel methods. In that regard, feature vector generation using CRO hash sets may provide a strong balance between the accuracy of non-linear kernel methods and the efficiency of linear kernels. As such, the features described herein may result in increased computation efficiency, reduced consumption of processing resources, and improvements in the efficiency and accuracy of real-time processing using machine learning. The features described herein may be useful for real-time applications that require both accuracy and speed in data processing, including applications such as anomaly detection in video streaming, high frequency trading, and fraud detection, for example.

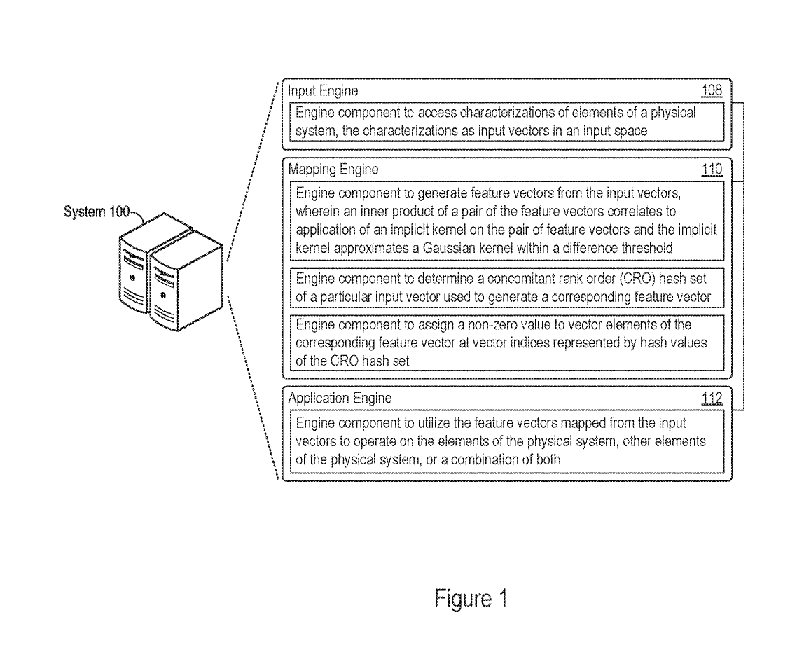

FIG. 1 shows an example of a system 100 that supports generation of feature vectors using CRO hash sets. The system 100 may take the form of any computing system, including a single or multiple computing devices such as servers, compute nodes, desktop or laptop computers, smart phones or other mobile devices, tablet devices, embedded controllers, and more.

The system 100 may generate feature vectors by mapping input vectors in an input space to feature vectors in a feature space. For a particular set of input vectors, the system 100 may generate a corresponding set of feature vectors. As described in greater detail below, the system 100 may generate sparse binary feature vectors from input vectors through use of concomitant rank order (CRO) hash sets determined for the input vectors. The system 100 may determine the CRO hash sets and generate the feature vectors in linear time, e.g., without costly vector product operations or other non-linear kernel training mechanisms that may consume significant processing resources.

Nonetheless, the feature vectors generated by the system 100 using the determined CRO hash sets may exhibit characteristics that approximate non-linear kernels trained using kernel methods or “kernel tricks”, including the Gaussian kernel in some examples. That is, the feature vectors generated by the system 100 may provide an accuracy similar to non-linear kernel methods, but also take the sparse binary form useful for linear kernels to support machine-learning applications with increased speed and efficiency. Such an accuracy may be unexpected as the feature vectors are generated without actual application of a non-linear kernel method. To further explain, the feature vectors generated by the system 100 may be efficiently generated without the computationally-expensive vector product operations required for non-linear kernel methods, but provide an unexpected accuracy usually characterized by such non-linear kernel methods. The system 100 may thus support feature vector generation with the accuracy of, for example, the Gaussian kernel, but also support the efficiency of linear kernels and other linear machine-learning mechanisms.

The system 100 may implement various engines to provide or support any of the features described herein. In the example shown in FIG. 1, the system 100 implements an input engine 108, a mapping engine 110, and an application engine 112. The system 100 may implement the engines 108, 110, and 112 (including components thereof) in various ways, for example as hardware and programming. The programming for the engines 108, 110, and 112 may take the form of processor-executable instructions stored on a non-transitory machine-readable storage medium, and the processor-executable instructions may, upon execution, cause hardware to perform any of the features described herein. In that regard, various programming instructions of the engines 108, 110, and 112 may implement engine components to support or provide the features described herein.

The hardware for the engines 108, 110, and 112 may include a processing resource to execute programming instructions. A processing resource may include various number of processors with single or multiple cores, and a processing resource may be implemented through a single-processor or multi-processor architecture. In some examples, the system 100 implements multiple engines using the same system features or hardware components (e.g., a common processing resource).

The input engine 108, mapping engine 110, and application engine 112 may include components to support the generation and application of feature vectors. In the example implementation shown in FIG. 1, the input engine 108 includes an engine component to access characterizations of elements of a physical system, the characterizations as input vectors in an input space. The mapping engine 110 may include the engine components shown in FIG. 1 to generate feature vectors from the input vectors, wherein an inner product of a pair of the feature vectors correlates to application of an implicit kernel on the pair of feature vectors and the implicit kernel approximates a Gaussian kernel within a difference threshold; determine a concomitant rank order (CRO) hash set of a particular input vector used to generate a corresponding feature vector; and to assign a non-zero value to vector elements of the corresponding feature vector at vector indices represented by hash values of the CRO hash set. As also shown in the example implementation of FIG. 1, the application engine 112 may include an engine component to utilize the feature vectors generated from the input vectors to operate on the elements of the physical system, other elements of the physical system, or a combination of both.

These and other aspects of feature vector generation using CRO hash sets are discussed in greater detail next.

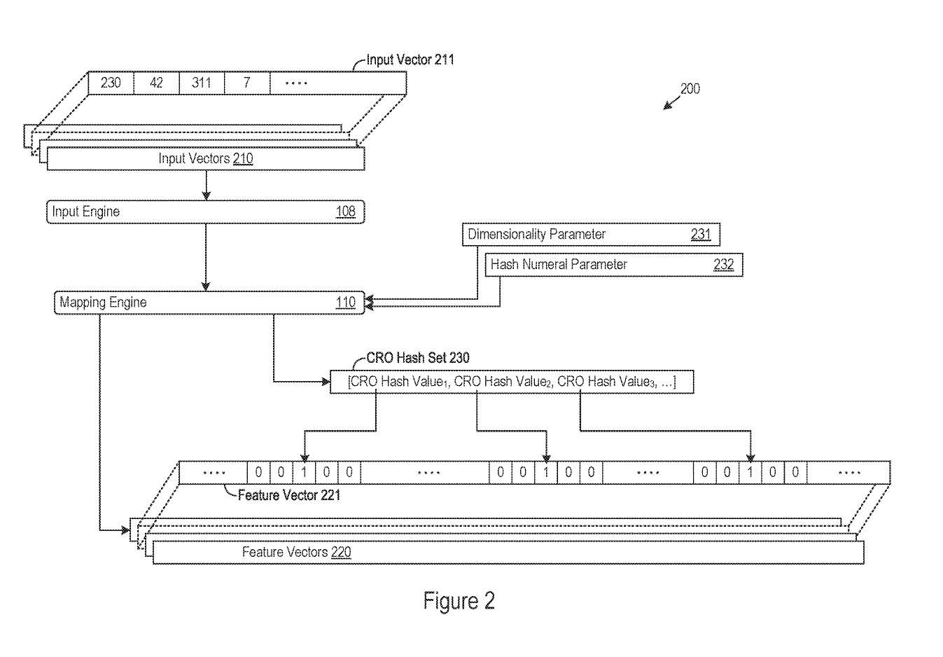

FIG. 2 shows an example of an architecture 200 that supports generation of feature vectors using CRO hash sets. The architecture 200 in FIG. 2 includes the input engine 108 and the mapping engine 110. The input engine 108 may receive a set of input vectors 210 for transformation or mapping into a feature space, e.g., for machine learning tasks or other applications. The input vectors 210 may characterize or otherwise represent elements of a physical system. Example physical systems include video streaming and analysis systems, banking systems, document repositories and analysis systems, medical facilities storing medical records and biological statistics, and countless other systems that store, analyze, or process data. In some examples, the input engine 108 receives the input vectors 210 as a real-time data stream for processing, analysis, classification, model training, or various other operations.

The input vectors 210 may characterize elements of a physical system in any number of ways. In some implementations, the input vectors 210 characterize elements of a physical system through a multi-dimensional vector storing vector element values representing various characteristics or aspects of the physical system elements. In the example shown in FIG. 2, the input vectors 210 include an example input vector labeled as the input vector 211. The input vector 211 includes vector elements with particular values, including the vector element values “230”, “42”, “311”, “7”, and more.

The mapping engine 110 may transform the input vectors 210 into the feature vectors 220. For each input vector received by the input engine 108, the mapping engine 110 may generate a corresponding feature vector, and do so by mapping the input vector in an input space to a corresponding feature vector in a feature space. In the example shown in FIG. 2, the mapping engine 110 generates, from the input vector 211, an example feature vector labeled as the feature vector 221.

To generate the feature vector 221 from the input vector 211, the mapping engine 110 may determine a CRO hash set of the input vector 211. The CRO hash set of an input vector may include a predetermined number of hash values through application of a CRO hash function, which is described in greater detail below. In FIG. 2, a determined CRO hash set for the input vector 211 is shown as the CRO hash set 230, which includes multiple hash values illustrated as “CRO Hash Value₁”, “CRO Hash Value₂”, and “CRO Hash Value₃”. The CRO hash set 230 may include more hash values as well.

The mapping engine 110 may determine a CRO hash set for an input vector according to any number of parameters. Two examples are shown in FIG. 2 as the dimensionality parameter 231 and the hash numeral parameter 232. The dimensionality parameter 231 may specify a universe of values from which the CRO hash values are computed from. As an illustrative example, the dimensionality parameter 231 may take the form of an integer value U, and the mapping engine 110 may determine the CRO hash set as hash values from the universe of 1 to U (e.g., inclusive). The hash numeral parameter 232 may indicate a number of CRO hash values to compute for an input vector, which may be explicitly and flexibly specified. Accordingly, the hash numeral parameter 232 may specify the size of the CRO hash sets determined for input vectors. The parameters 231 and 232 may be configurable, specified as system parameters, or user-specified. As example values, the dimensionality parameter 231 may have a value of 65,536 (i.e., 2̂16) and the hash numeral parameter 232 may have a value of 500.

Table 1 below illustrates an example process by which the mapping engine 110 may determine the CRO hash set for an input vector A. In Table 1, the input vector A may be defined as AεR^{N}. In implementing or performing the example process, the mapping engine 110 may map input vectors to a CRO hash set with hash values chosen from the universe of 1 to U, where U is specified via the dimensionality parameter 231. The mapping engine 110 may also compute CRO hash sets using the hash numeral parameter 232, which may specify the number of hash values to compute for an input vector and which may be denoted as τ. As another part of the example CRO hast set computation process shown in Table 1, the mapping engine 110 may access, compute, or use a random permutation π of 1-U. The mapping engine 110 may utilize the same random permutation π for a particular set of input vectors or for input vectors of a particular source or particular vector type.

Referring now to Table 1 below, the vector −A represents the input vector A multiplied by −1 and the notation A, B, C, . . . represents the concatenation of vectors A, B, C etc.

TABLE 1
Example Process to Compute a CRO Hash Set

| | |
|---|---|
| 1) | Let Â = A, − A |
| 2) | Create a repeated input vector A′ as follows: |

${A}^{′} = {\underbrace{\hat{A} , \hat{A} , … , \hat{A}}}_{d} {\underbrace{000}}_{r}$
where d = U div |Â| and r = U mod |Â|. Note that div represents integer
division. Thus |A′| = 2dN + r = U.

| | |
|---|---|
| 3) | Apply the random permutation π to A′ to get permuted input vector |
| | V. |
| 4) | Calculate the Hadamard Transform of V to get S. If an efficient |
| | implementation of the Hadamard Transform is not available, use |
| | another orthogonal transform, for example the DCT transform. |
| 5) | Find the indices of the smallest τ members of S. These indices are |
| | identified as the CRO hash set of the input vector A. |

Table 2 below illustrates example pseudo-code that the mapping engine 110 may implement or execute to determine CRO hash sets for input vectors. The pseudo-code below may be consistent with the form of Matlab code, but other implementations are possible.

TABLE 2
Example Pseudo-Code for CRO Hast Set Computation

function hashes = CPOHash(A,U,P,tau)
% A is the input vector.
% U is the size of the hash universe.
% P is a random permutation of 1:U chosen once and used in all hash
%% calculations.
% tau is the desired number of hashes E=zeros(1,U);
AHat = [A,−A];
N2=length(AHat); d=floor(U/N2);
for i=0:d−1
E(i*N2+1: (i+1) *N2) =AHat;
end
Q=E(P);
% If an efficient implementation of
% the Walsh-Hadamard transform is
% available, use it instead, i.e.
% S=fwht(Q);
S=dct(Q);
[^{~},ix]=sort(S);
hashes=ix(1:tau);

As such, the mapping engine 110 may determine (e.g., compute) CRO hash sets for each of the input vectors 210.

Upon determining the CRO hash set for a particular input vector, the mapping engine 110 may generate a corresponding feature vector from the CRO hash set. In particular, the mapping engine 110 may generate the corresponding feature vector as a vector with dimensionality U (that is, the dimensionality parameter 231). Accordingly, the corresponding feature vector may have a number of vector elements (or, phrased another way, a vector length) equal to the dimensionality parameter 231. The mapping engine 110 may assign values to the U number of vector elements in the corresponding feature vector according to the CRO hash set for the input vector from which the feature vector is mapped or generated from.

To illustrate, the CRO hash set determined for an input vector may include a number of hash values, each between 1 and U, and the mapping engine 110 may use the CRO hash values in the CRO hash set as vector indicies into the feature vector. For each vector element with a vector index represented by a hash value of the CRO hash set, the mapping engine 110 may assign a non-zero value in the feature vector (e.g., a ‘1’ value). For other vector elements with vector indices in the feature vector not represented by the hash values of the determined CRO hash set, the mapping engine 110 may assign a zero value (also denoted as a ‘0’ value). Such an example is shown in FIG. 2, where the mapping engine 110 assigns a ‘1’ value to vector elements in the feature vector 221 represented by vector indices equal to the hash values “CRO Hash Value₁”, “CRO Hash Value₂”, “CRO Hash Value₃”, etc. In the example in FIG. 2, the feature vector 221 includes ‘0’ values assigned by the mapping engine 110 for the other vector elements with vector indices not represented by the hash values of the CRO hash set 230.

In some implementations, feature vectors generated by the mapping engine 110 using CRO hash sets may be sparse, binary, and high-dimensional. The sparsity, high-dimensional, and binary characteristics of feature vectors generated by the mapping engine 110 may provide increased efficiency in subsequent machine-learning or other processing using the feature vectors.

Regarding sparsity, the sparsity of a feature vector may be measured through the ratio of non-zero vector elements present in the feature vector (which may be equal to the hash numeral parameter 232) to the total number of elements in the feature vector (which may be equal to the dimensionality parameter 231). Thus, the sparsity of the feature vector 221 may be measured as the value of the hash numeral parameter 232/dimensionality parameter 231. Generated feature vectors may be considered sparse when the sparsity of the feature vector is less than a sparsity threshold, e.g., less than 0.25% or any other configurable or predetermined value.

Regarding dimensionality, the generated feature vectors may be high-dimensional when the vector length of the feature vectors exceeds a high-dimensional threshold. As noted above, the vector length of feature vectors generated by the mapping engine 110 may be controlled through the dimensionality parameter 231. Thus, generated feature vectors may be high-dimensional when the dimensionality parameter 231 (and thus the number of elements in the feature vectors) is set to a value that exceeds the high-dimensional threshold. As an example, a feature vector may be high-dimensional when the vector length exceeds 50,000 elements or any other configurable threshold. Regarding the binary vector characteristic, the mapping engine 110 may generate feature vectors to be binary by assigning a ‘1’ value to the vector elements with vector indices represented by the hash values of computed CRO hash sets. Such binary vectors may be subsequently processed with increased efficiency, and thus the mapping engine 110 may improve computer performance for data processing and various machine-learning tasks.

As described above, the mapping engine 110 may generate a set of feature vectors from a set of input vectors using the CRO hash sets determined for the input vectors. The resulting set of feature vectors may exhibit various characteristics that may be beneficial to subsequent processing or use. In particular, feature vectors generated using CRO hash sets may correlate to (e.g., approximate or equate to) an “implicit” kernel. Such a kernel is referred to as “implicit” as the mapping engine 110 may generate feature vectors without explicit application of a kernel, without vector product operations, and without various other costly computations used in non-linear kernel methods. However, the generated feature vectors may be correlated (e.g., characterized) by this implicit kernel as the inner product of generated feature vectors results in this implicit kernel.

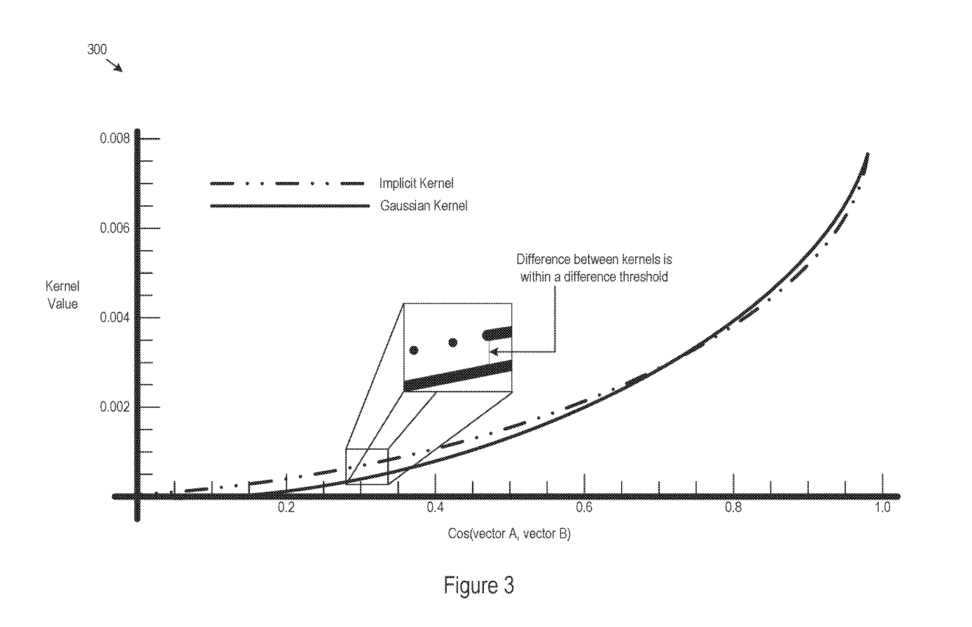

The implicit kernel (correlated to feature vectors generated using CRO hash sets) may approximate other kernels used in non-linear kernel methods. In some examples, the implicit kernel approximates the Gaussian kernel, which may also be referred to as the radial basis function (RBF) kernel. The implicit kernel may approximate the Gaussian kernel (or other kernels) within a difference threshold. The difference threshold may refer to a tolerance for the difference between kernel values of the implicit kernel and the Gaussian kernel, and may expressed in absolute values (e.g., difference is within 0.001) or in percentage (e.g., difference is within 5%). One such comparison is shown in FIG. 3.

FIG. 3 shows an example graph 300 to illustrate how an implicit kernel may differ from a Gaussian kernel by less than a difference threshold. In particular, FIG. 3 shows a comparison for vectors A and B on the unit sphere, e.g., ∥A∥=∥B∥=1. The dotted line illustrates example kernel values for the implicit kernel (correlated to feature vectors generated using CRO hash sets) as well as a Gaussian kernel, which may be expressed as:

$${αe}^{\frac{log ( α )}{2} {‖ A - B ‖}^{2}} with a parameter of log ( α ) .$$

Thus, the example graph 300 may illustrate how at no point does the difference in kernel value between the implicit kernel and the Gaussian kernel exceed a difference threshold (e.g., a 0.001 value or 5%) for various x-axis values of the graph 300 (shown as cos(A, B)).

By approximating the Gaussian kernel, the implicit kernel may exhibit increased accuracy in application of feature vectors generated using CRO hash sets (to which the implicit kernel is correlated). In that regard, the mapping engine 110 may generate feature vectors using CRO hash sets with increased efficiency and lower computational times (as no vector product operations are necessary), but nonetheless provide accuracy and utility of non-linear kernel methods. As noted above, such a combination of accuracy and speed may be unexpected as linear kernels lack the accuracy and effectiveness exhibited by feature vectors generating using CRO hash sets and input-to-feature mapping through non-linear kernel methods are much more computationally expensive. Such feature vectors may thus provide elegant and efficient elements for use in machine-learning, classification, clustering, regression, and particularly for real-time analysis of large sampling data sets such as streaming applications, fraud detection, high-frequency trading, and much more.

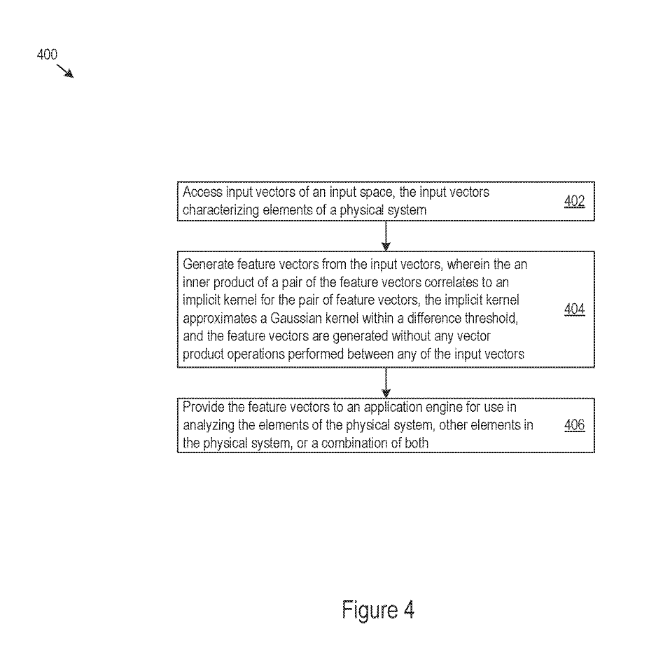

FIG. 4 shows a flow chart of an example method 400 for feature vector generation. Execution of the method 400 is described with reference to the input engine 108, the mapping engine 110, and the application engine 112, though any other device, hardware-programming combination, or other suitable computing system may execute any of the steps of the method 400. As examples, the method 400 may be implemented in the form of executable instructions stored on a machine-readable storage medium and/or in the form of electronic circuitry.

The method 400 may include accessing input vectors in an input space, the input vectors characterizing elements of a physical system (402). In some examples, the input engine 108 may access the input vectors in real-time, for example as a data stream for anomaly detection in video data, as data characterizing high frequency trading, as image recognition data, or various online applications.

The method 400 may also include generating feature vectors from the input vectors (404), for example by the mapping engine 110. The feature vectors generated by the mapping engine 110 may correlate to input-feature vector transformations using an implicit kernel. Thus, an inner product of a pair of the feature vectors may correlate to an implicit kernel for the pair of feature vectors and the implicit kernel may approximate a Gaussian kernel within a difference threshold. Moreover, the mapping engine 110 may generate the feature vectors without any vector product operations performed between any of the input vectors, which may allow for efficient feature vector computations with increased an unexpected accuracy.

As shown in FIG. 4, the method 400 may further include providing the feature vectors to an application engine for use in analyzing the elements of the physical system, other elements in the physical system, or a combination of both (406). In some implementations, the mapping engine 110 provides the generated feature vectors to an application engine 112 for use in classification, regression, or clustering applications. For instance, the application engine 112 may include a linear classifier, in which case the mapping engine 110 may provide the feature vectors to the linear classifier to train an application model for classifying the elements of the physical system. When the application engine 112 includes a clustering engine, the mapping engine 110 may provide the feature vectors to the clustering engine to cluster the elements of the physical system. As yet another example, the mapping engine 110 may provide the feature vectors to a regression engine to perform a regression analysis for the elements of the physical system when the application engine 112 includes a regression engine.

Although one example was shown in FIG. 4, the steps of the method 400 may be ordered in various ways. Likewise, the method 400 may include any number of additional or alternative steps as well, including steps implementing any other aspects described herein with respect to the input engine 108, mapping engine 110, application engine 112, or combinations thereof.

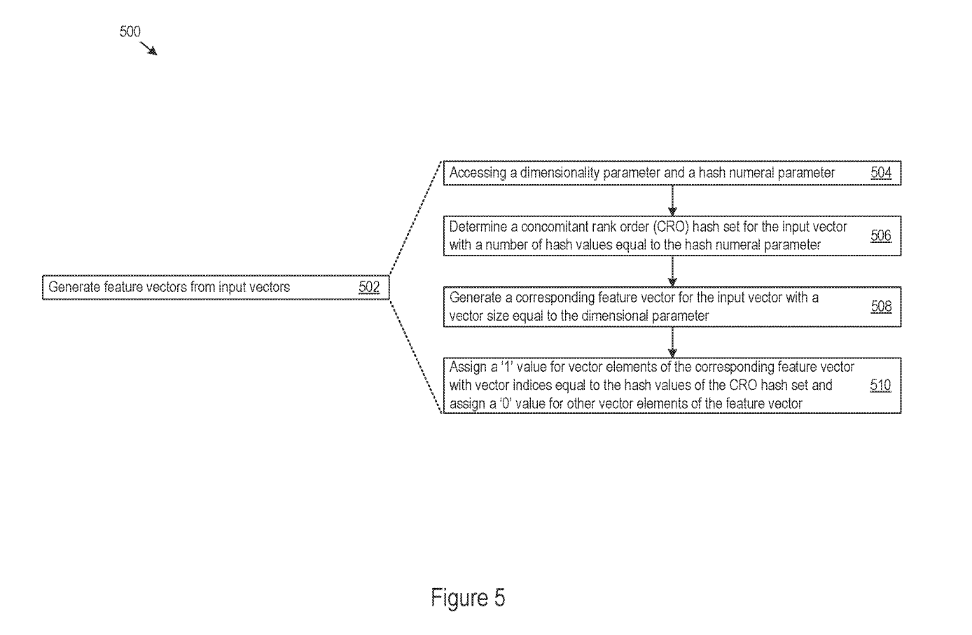

FIG. 5 shows a flow chart of an example method 500 for feature vector generation. Execution of the method 500 is described with reference to the mapping engine 110. Though as similarly noted above, any other device, hardware-programming combination, or other suitable computing system may execute any of the steps of the method 500. As examples, the method 500 may be implemented in the form of executable instructions stored on a machine-readable storage medium and/or in the form of electronic circuitry.

The method 500 may include generating feature vectors from input vectors (502), for example by the mapping engine 110. The mapping engine 110 may generate the feature vectors in any of the ways described herein. For instance, for the method 500 shown in FIG. 5, feature vector generation may include accessing a dimensionality parameter and a hash numeral parameter (504). The method 500 may also include, for each input vector of the input vectors, determining a CRO hash set for the input vector with a number of hash values equal to the hash numeral parameter (506); generating a corresponding feature vector for the input vector with a vector size equal to the dimensional parameter (508); and assigning a ‘1’ value for vector elements of the corresponding feature vector with vector indices equal to the hash values of the CRO hash set and assigning a ‘0’ value for other vector elements of the feature vector (510).

The feature vectors generated by the mapping engine 110 may be high-dimensional, binary, and sparse. For instance, the dimensionality parameter accessed by the mapping engine 110 may exceed a high-dimension threshold, which may thus case the mapping engine 110 to generate high-dimensional feature vectors. As another example, the mapping engine 110 may access the parameters such that a ratio between the hash numeral parameter and the dimensionality parameter is less than a sparsity threshold. In such examples, the mapping engine 110 may generate the corresponding set of feature vectors as sparse binary feature vectors.

Although one example was shown in FIG. 5, the steps of the method 500 may be ordered in various ways. Likewise, the method 500 may include any number of additional or alternative steps as well, including steps implementing any other aspects described herein with respect to the input engine 108, mapping engine 110, application engine 112, or combinations thereof.

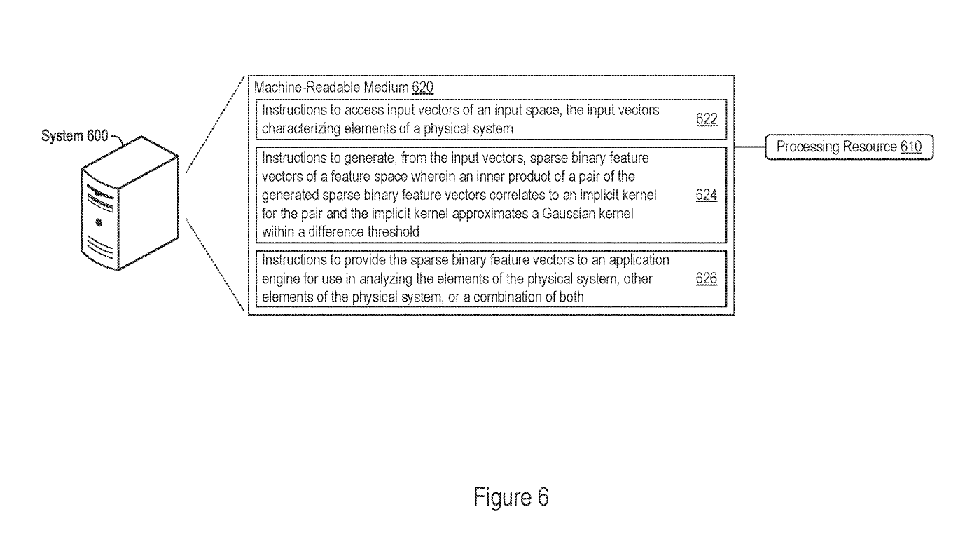

FIG. 6 shows an example of a system 600 that supports generation of feature vectors. The system 600 may include a processing resource 610, which may take the form of a single or multiple processors. The processor(s) may include a central processing unit (CPU), microprocessor, or any hardware device suitable for executing instructions stored on a machine-readable medium, such as the machine-readable medium 620 shown in FIG. 6. The machine-readable medium 620 may be any non-transitory electronic, magnetic, optical, or other physical storage device that stores executable instructions, such as the instructions 622, 624, and 626 in FIG. 6. As such, the machine-readable medium 620 may be, for example, Random Access Memory (RAM) such as dynamic RAM (DRAM), flash memory, memristor memory, spin-transfer torque memory, an Electrically-Erasable Programmable Read-Only Memory (EEPROM), a storage drive, an optical disk, and the like.

The system 600 may execute instructions stored on the machine-readable medium 620 through the processing resource 610. Executing the instructions may cause the system 600 to perform any of the features described herein, including according to any features of the input engine 108, the mapping engine 110, the application engine 112, or combinations thereof.

For example, execution of the instructions 622 and 624 by the processing resource 610 may cause the system 600 to access input vectors in an input space, the input vectors characterizing elements of a physical system (instructions 622) and generate, from the input vectors, sparse binary feature vectors in a feature space different from the input space (instructions 624). An inner product of a pair of the generated sparse binary feature vectors may correlate to an implicit kernel for the pair, and the implicit kernel may approximate a Gaussian kernel within a difference threshold, e.g., for the unit sphere. Generation of each sparse binary feature vector may be performed without any vector product operations, including without any vector product operations amongst the input vectors. Instead, generation of the sparse binary feature vectors may include determination of a CRO hash set for an input vector corresponding to a sparse binary feature vector; assignment of a ‘1’ value for vector elements of the sparse binary feature vector with vector indices equal to hash values of the CRO hash set; and assignment of a ‘0’ value for other vector elements of the sparse binary feature vector. In some implementations, each of the generated sparse binary feature vectors is sparse by having a ratio of vector elements with a ‘1’ value to total vector elements that is less than a sparsity threshold.

Continuing the example of FIG. 6, execution of the instructions 626 by the processing resource 610 may cause the system 600 to provide the sparse binary feature vectors to an application engine for use in analyzing the elements of the physical system, other elements of the physical system, or a combination of both. Although some example instructions are shown in FIG. 6, the machine-readable medium 620 may include instructions that support any of the feature vector generation and mapping features described herein.

The systems, methods, devices, engines, and logic described above, including the input engine 108, mapping engine 110, and application engine 112, may be implemented in many different ways in many different combinations of hardware, logic, circuitry, and executable instructions stored on a machine-readable medium. For example, the input engine 108, the mapping engine 110, the application engine 112, or any combination thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the input engine 108, mapping engine 110, and application engine 112.

The processing capability of the systems, devices, and engines described herein, including the input engine 108, mapping engine 110, and application engine 112, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A system comprising:
an input engine to access characterizations of elements of a physical system, the characterizations as input vectors in an input space;
a mapping engine to generate feature vectors in a feature space from the input vectors, wherein an inner product of a pair of the feature vectors correlates to an implicit kernel for the pair of feature vectors and the implicit kernel approximates a Gaussian kernel within a difference threshold, and wherein generation of the feature vectors comprises:
determination of a concomitant rank order (CRO) hash set of a particular input vector used to generate to a corresponding feature vector;
assignment of a non-zero value to vector elements of the corresponding feature vector at vector indices represented by hash values of the CRO hash set; and
an application engine to utilize the feature vectors generated from the input vectors to operate on the elements of the physical system, other elements of the physical system, or a combination of both.

2. The system of claim 1, wherein the mapping engine is further to generate the feature vectors through:
assignment of a zero value to vector elements of the corresponding feature vector at vector indices not represented by the hash values of the CRO hash set.

3. The system of claim 1, wherein the mapping engine is to assign the non-zero value as a ‘1’ value to vector elements of the feature vector; and
wherein the feature vectors generated by the mapping engine are binary vectors.

4. The system of claim 1, wherein the feature vectors generated by the mapping engine are sparse vectors with a ratio of non-zero vector elements to total vector elements that is less than a sparsity threshold.

5. The system of claim 1, wherein the feature vectors generated by the mapping engine are high-dimensional vectors with a total number of vector elements that exceeds a high-dimension threshold.

6. The system of claim 1, wherein the application engine comprises a linear classifier, a clustering engine, a regression engine, or any combination thereof.

7. A method comprising:
accessing input vectors in an input space, the input vectors characterizing elements of a physical system;
generating feature vectors from the input vectors, wherein:
an inner product of a pair of the feature vectors correlates to an implicit kernel for the pair of feature vectors;
the implicit kernel approximates a Gaussian kernel within a difference threshold; and
the feature vectors are generated without any vector product operations performed between any of the input vectors; and
providing the feature vectors to an application engine for use in analyzing the elements of the physical system, other elements in the physical system, or a combination of both.

8. The method of claim 7, wherein the generating comprises:
accessing a dimensionality parameter and a hash numeral parameter;
for each input vector of the input vectors:
determining a concomitant rank order (CRO) hash set for the input vector with a number of hash values equal to the hash numeral parameter;
generating a corresponding feature vector for the input vector with a vector size equal to the dimensional parameter; and
assigning a ‘1’ value for vector elements of the corresponding feature vector with vector indices equal to the hash values of the CRO hash set and assigning a ‘0’ value for other vector elements of the feature vector.

9. The method of claim 8, wherein the dimensionality parameter exceeds a high-dimension threshold.

10. The method of claim 8, wherein a ratio between the hash numeral parameter and the dimensionality parameter is less than a sparsity threshold; and
wherein the corresponding feature vectors are sparse binary feature vectors.

11. The method of claim 7, wherein the application engine comprises a linear classifier; and
wherein providing comprises providing the feature vectors to the linear classifier to train an application model for classifying the elements of the physical system.

12. The method of claim 7, wherein the application engine comprises a clustering engine; and
wherein providing comprises providing the feature vectors to the clustering engine to cluster the elements of the physical system.

13. The method of claim 7, wherein the application engine comprises a regression engine; and
wherein providing comprises providing the feature vectors to the regression engine to perform a regression analysis for the elements of the physical system.

14. A non-transitory machine-readable medium comprising instructions executable by a processing resource to:
access input vectors in an input space, the input vectors characterizing elements of a physical system;
generate, from the input vectors, sparse binary feature vectors in a feature space, wherein:
an inner product of a pair of the generated sparse binary feature vectors correlates to an implicit kernel for the pair and the implicit kernel approximates a Gaussian kernel within a difference threshold;
generation of each sparse binary feature vector is performed without any vector product operations, and comprises:
determination of a concomitant rank order (CRO) hash set for an input vector corresponding to the sparse binary feature vector;
assignment of a ‘1’ value for vector elements of the sparse binary feature vector with vector indices equal to hash values of the CRO hash set; and
assignment of a ‘0’ value for other vector elements of the sparse binary feature vector; and
provide the sparse binary feature vectors to an application engine for use in analyzing the elements of the physical system, other elements of the physical system, or a combination of both.

15. The non-transitory machine-readable medium of claim 14, wherein each of the sparse binary feature vectors is sparse by having a ratio of vector elements with a ‘1’ value to total vector elements that is less than a sparsity threshold.
